(19) United States
(12) Patent Application Publication
(10) Pub. No.: US 2006/0126767 A1
(43) Pub. Date: Jun. 15, 2006

(54) Simple filter to remove imperfection

(76) Inventor: Kiomars Anvari, Alamo, CA (US)

Correspondence Address: Kiomars Anvari, 1567 SERAFIX RD, ALAMO, CA, 94507, US

(21) Appl. No.: 11/007,952

(22) Filed: Dec. 9, 2004

(51) Int. Cl. H04B 1/10

(52) U.S. Cl. 375/350

(57) ABSTRACT

A filtering technique to remove imperfection from a signal that has been subject to channel imperfection is described. The output from any channel with imperfection is modified by a simple filter that minimizes any inter-symbol interference as well as removing un-wanted spectrum. The simple filtering can either be performed at baseband or RF/IF frequencies. To achieve its objectives the filter uses both real frequency and imaginary frequency zeros as well as poles in its transfer function. By adjusting location of these zeros the amplitude response of the filter alters without any change in its phase response. The filter could be realized in digital or analog domain.

### BACK GROUND OF INVENTION

The present invention relates to a filter circuit that improves the signal by minimizing any imperfection that caused by various components of a channel. The filter input could be baseband, intermediate frequency (IF), or RF signal. and its output is an improved baseband or IF/RF signal. In any wireless communication system one of the critical components is the channel filter. This component has a major contribution in performance of the system. The main reason is the requirement of any communication system for channels with minimum imperfection. The higher the channel imperfection, the lower the system performance. To maintain the performance in wireless system higher transmit power is required. In order to minimize the cost, size and power consumption there is a need for techniques that minimizes the channel imperfections. This invention conquers these challenges by using a simple imperfection minimizing filter used in any communication channel.

### SUMMARY OF INVENTION

According to the invention, an imperfection minimizing filter, for use with communication channels, uses a plurality of simple and accurate circuits in conjunction with intelligent signal processing to improve the performance of a communication channel. By intelligent, it is meant that the filter has features of minimizing the unwanted imperfection produced by components of the communication channel. The input to the imperfection minimizing filter could be a baseband, an IF or RF signal. The imperfection minimizing filter helps to improve the performance of the communication channel.

In a particular embodiment, the imperfection minimizing filter comprises of poles as well as real and imaginary frequency zeros. Depending on the nature of the signal, and channel imperfection the number of poles and zeros will vary. In the case of baseband signal the filter will be of low pass nature and in case of IF/RF signal the filter has band pass properties. In both cases the filter can be either implemented in digital or analog domain.

The invention will be better understood by reference to the following detailed description in conjunction with the accompanying drawings.

### BRIEF DESCRIPTION OF THE DRAWINGS

FIG. 1 is an overall block diagram of the communication channel with imperfection.

FIG. 2 is the poles and zeros of baseband equivalent of imperfection minimizing filter.

### DESCRIPTION OF THE SPECIFIC EMBODIMENTS

In a first preferred embodiment of the invention, the imperfection minimizing filter is implemented at baseband or RF/IF frequency. In a second preferred embodiment of the invention, the imperfection minimizing filter poles can represent any of the conventional filters. In a third preferred embodiment of the invention the imperfection minimizing filter has zeros on the real frequency axis. In a forth embodiment of the invention the imperfection minimizing filter has zeros on the imaginary frequency axis. In a fifth embodiment of the invention the imperfection minimizing filter improves the performance of the channel by adjusting its real and imaginary frequency zeros.

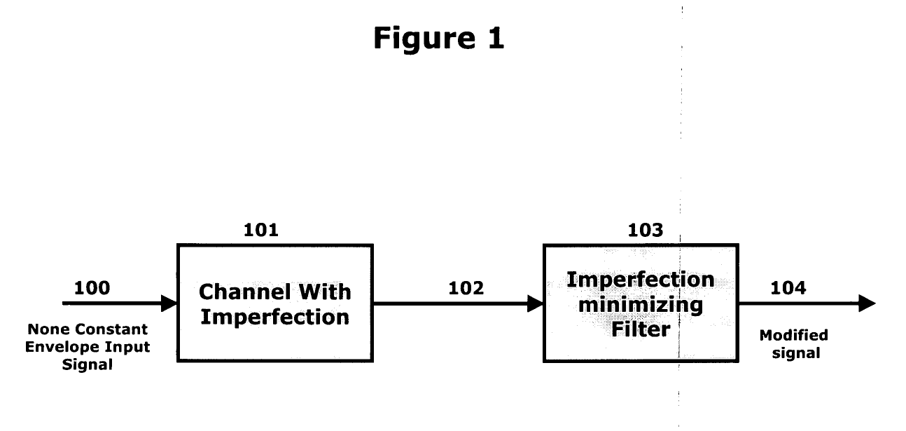

Referring to FIG. 1, a communication channel with imperfection minimizing filter is illustrated. The input to the communication channel is the non-constant envelop signal 100. The channel 101 introduce imperfection to the non-constant envelop signal 100 and produce imperfect signal 102. The imperfect signal is applied to imperfection minimizing filter 103 to create the modified signal 104. The imperfection minimizing filter perform the following:

1. Minimizes the unwanted signals created by imperfect channel.

2. Rejects any available interference.

3. Improves the signal to noise ratio of the non-constant envelope signal.

4. Has its zeros and poles configurable

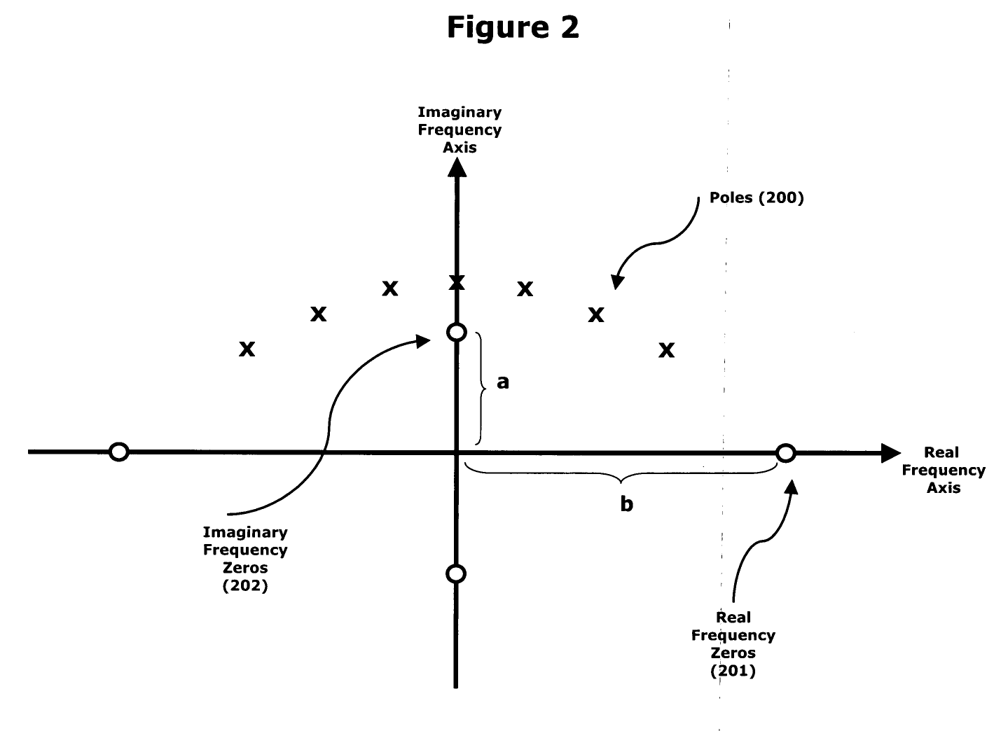

FIG. 2 illustrates the detail block diagram of the poles and zeros of imperfection minimizing filter. This diagram shows the baseband equivalent poles and zeros of the filter. The poles 200 can represent any type of the conventional and unconventional filter. The zeros 201 are used to provide out of band rejection. The zeros 202 are used to enhance the in band signal to noise ration.

What is claimed is:

1. A imperfection minimizing filter for use with non-constant envelope signals in any communication channel to enhance the performance of the channel, in particular wireless cellular, PCS, wireless LAN, line of sight microwave, military, and satellite communication systems and any other none wireless applications, the imperfection minimizing filter comprising of:
A filter with poles similar to any conventional and unconventional filter.
A filter with real frequency zeros.
A filter with imaginary frequency filters.
A filter with configurable real and imaginary zeros.
A filter with configurable poles.

2. The imperfection minimizing filter according to claim 1, wherein the imperfection minimizing filter is a band pass filter implemented at RF/IF signal frequencies.

3. The imperfection minimizing filter according to claim 1, wherein the imperfection minimizing filter is a low pass filter.

4. The imperfection minimizing filter according to claim 1, wherein the zeros of the imperfection minimizing filter are configured to achieve the out of band rejection.

5. The imperfection minimizing filter according to claim 1, wherein the zeros of the imperfection minimizing filter are configured to achieve signal to noise enhancement.

6. The imperfection minimizing filter according to claim 1, wherein the poles of the imperfection minimizing filter are configured in an unconventional arrangement to achieve the required pass band amplitude and group delay response.

7. The imperfection minimizing filter according to claim 1, wherein the poles of the imperfection minimizing filter are chosen based on conventional filters according to band pass amplitude and group delay requirement of the filter.

8. The imperfection minimizing filter according to claim 1, wherein the number of poles and zeros of the imperfection minimizing filter controlled by implementation and filter being realizable.

9. The imperfection minimizing filter according to claim 1 and subsequent claims, when it is used in wireless cellular, wireless PCS, wireless LAN, microwave, wireless satellite, none wireless communication channels, and any wireless communication systems used for military applications.

10. The imperfection minimizing filter according to claim 1, wherein the imperfection minimizing filter can be implemented in analog lumped elements, programmable logic, FPGA, Gate Array, ASIC, and DSP processor
